(19) United States
(12) Patent Application Publication
(10) Pub. No.: US 2005/0029299 A1
(43) Pub. Date: Feb. 10, 2005

(54) Insulating liner for drink container

(76) Inventor: Jennifer Switzer, Springfield, TN (US)

Correspondence Address: MICHAEL P. MAZZA, LLC, 686 CRESCENT BLVD., GLEN ELYN, IL, 60137, US

(21) Appl. No.: 10/909,666

(22) Filed: Aug. 2, 2004

Related U.S. Application Data
(60) Provisional application No. 60/492,110, filed on Aug. 4, 2003.

(51) Int. Cl. B67B 7/00

(52) U.S. Cl. 222/183; 62/457.3

(57) ABSTRACT

A liner for insulating a beverage within a frozen drink container. The liner is preferably generally shaped and sized to conform to the shape and size of the drink container. Once the liner is inserted within the container, and a beverage is poured into the container, the beverage is contained and insulated by the liner. The container is preferably made of a break-resistant plastic resin. A removable top may be provided for the lined container, which may provide an air-tight and peelable seal for a ready-to-drink beverage contained there.

### CONTINUATION INFORMATION

This application claims priority, as to common subject matter, from a provisional patent application filed Aug. 4, 2003 by the same inventor, U.S. Ser. No. 60/492,110, titled “Frozen Drink Styrofoam Cup Liner.”

### BACKGROUND OF THE INVENTION

The present invention relates to insulating drink containers. More specifically, the invention provides a way to insulate drinks, such as to maintain frozen drinks in a chilled condition.

Cooling and insulating holders such as sleeves or cozies are known for maintaining cooled drinks such as beer. See, e.g., U.S. Pat. No. 4,793,149 to Riche. Styrofoam and other containers for entirely enclosing cooled drinks within the container are of course known. One example of such a device is shown in U.S. Pat. No. 6,474,096 to Felix de la Guardia.

These prior art devices have several disadvantages, including disadvantages that specifically apply to frozen drinks such as margaritas. Alcoholic and also non-alchoholic drinks, including frozen drinks, often come in irregular-shaped containers, such as the margarita glass shown in FIG. 1, so it may not be practical to insulate their outside surface area as with sleeves or cozies. Also, such drinks may not be sealed, so placement in large containers such as ice chests may not be desirable as their contents may spill or the often glass containers may break.

Accordingly, it is desirable to provide a device for insulating drinks, such as frozen drinks, that overcomes these problems.

### SUMMARY OF THE INVENTION

The present invention overcomes disadvantages of prior insulating and/or cooling devices for beverages, and provides new advantages.

In one embodiment of the present invention, a disposable liner for insulating a beverage within a drink container is provided. The liner is made of a disposable, insulating material, such as styrofoam, generally shaped and sized so as to be insertable within an interior of the drink container. The drink container may be made of glass or, preferably, a non-breakable material such as a plastic resin. When a beverage is poured into the drinking container, the beverage is contained and insulated by the liner, providing the ability to maintain the beverage in its initial condition, whether chilled or heated, for a substantially longer period of time than if the beverage were in an unlined container. The beverage may include frozen or non-frozen or heated drinks, which may be alcoholic or non-alcoholic drinks. Preferably the liner substantially covers the interior of the drink container.

The liner may be colored to correspond to or to coordinate with a particular beverage within the drink container and/or to correspond to or to coordinate with a color or colors of the beverage container.

To facilitate manipulation of the liner, and to avoid seepage of the beverage against the container, the liner may extend above the top of the container. To limit relative movement between the container and the liner during use, the liner may include a groove for mating with a rim of the container.

The lined container may be provided with a removable top designed to fit over the liner so as to substantially enclose the beverage within the liner and the top. This may be desirable in certain environments such as the beach where sand might otherwise enter the container. It might also be desirable to increase insulating efficiency where there is a significant delay between pouring or opening the drink, and drinking it. The removable top may but need not be insulating, may be peelable from the liner and/or container, and may hermetically seal a ready-to-drink beverage, such as a frozen margarita, within the lined enclosure and removable top.

When used in informal environments (e.g., the beach, picnics or other outdoor settings), for example, the container may consist only of a disposable, insulating enclosure, supported by a removable base, to enhance portability and ease of use.

### BRIEF DESCRIPTION OF THE DRAWINGS

The novel features which are characteristic of the invention are set forth in the appended claims. The invention itself, however, together with further objects and attendant advantages thereof, will be best understood by reference to the following description taken in connection with the accompanying drawings, in which:

FIG. 1 is a perspective, exploded view of one preferred embodiment of the invention, a frozen margarita glass and liner;

FIG. 2 is a perspective view of the glass shown in FIG. 1, now with the fitted liner; and

FIG. 3 is a partial side view along reference line 3-3 shown in FIG. 2.

### DEFINITION OF CLAIM TERMS

The terms used in the claims of the patent as filed are intended to have their broadest meaning consistent with the requirements of law.

“Drink container” means a cup, glass or other housing for a beverage which is intended to be directly consumed by a user from that container.

Where alternative meanings are possible, the broadest meaning is intended. All words used in the claims are intended to be used in the normal, customary usage of grammar and the English language.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

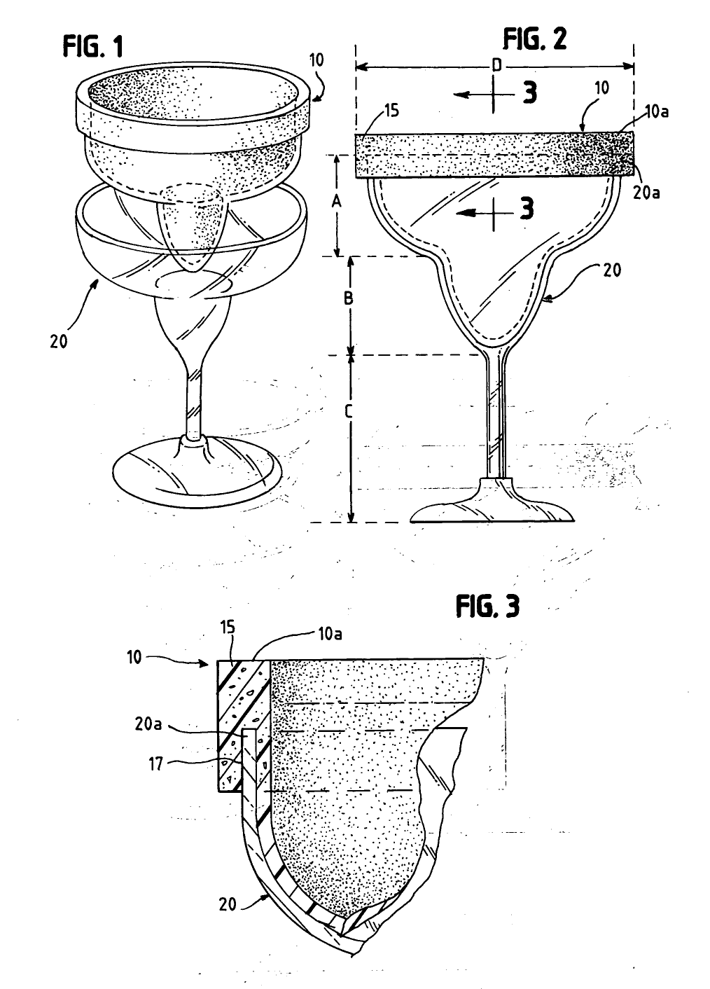

In accordance with a preferred embodiment of the invention, a liner for use insulating a beverage, such as for maintaining a frozen drink such as a frozen margarita in a chilled condition, is shown in FIG. 1 and designated generally with the reference numeral 10. Liner 10 is shaped and sized to fit within a beverage container 20, such as margarita glass 20, as shown in FIG. 1. In one preferred embodiment, liner 10 is made of styrofoam or another economically available, insulating material. Preferably, liner 10 is generally shaped and sized to correspond to the size and shape of the interior of container 20, so that it may be inserted into the interior of glass 20.

Referring to FIGS. 2 and 3, liner 10 preferably includes a tab portion 15 with a groove 17 into which rim 20a of container 20 may be inserted. Groove 17 prevents liner 10 from moving in relation to the container, and also helps to prevent seepage of the beverage between the liner and the container. In order to form the groove, it may be desirable to provide the liner with a thickened lip or tab portion 15.

Liner 10 is preferably disposable. It may also be colored to correspond to or to coordinate with the color of the beverage container 20 and/or with the type of beverage used (e.g. green liner and green container, or yellow liner and pink container, etc.) One company which colors styrofoam is Sunshine Merchandise Corporation, of Yiwu City, Zhejiang, China. The disposable liner may also be imprinted with words, logos, etc., in connection with a specific party or other event.

The use of a disposable liner makes cleaning of beverage container 20 easier. Margaritas, for example, leave a lime, etc. residue on the glass; with the present invention, if a sealed liner is used so that the beverage does not come into contact with container 20, disposing the used liner leaves a relatively clean container or glass.

It was discovered that using an approximate ¼-inch thick styrofoam liner (similar to that used for styrofoam coffee cups) insertable into the interior of the margarita glass generally shown in FIG. 2, is a preferred liner that provides excellent insulating results. For example, for insulation comparison purpose, four ounces of frozen margarita was poured into each of a traditional margarita glass (similar to that shown in FIG. 1), a similarly-shaped acrylic plastic container, and a conventional sytrofoam coffee cup of about ¼-inch thickness. A frozen margarita in the liner-less glass fully melted in 15 minutes, while a margarita in the acrylic container fully melted in 22 minutes. Surprisingly, the frozen margarita in the styrofoam cup did not fully melt until about 95 minutes had elapsed.

It is currently believed that a suitable styrofoam die may be tooled to prepare suitably-shaped styrofoam liners for use with particular shapes and sizes of beverage containers, perhaps using an injection molding process, although the inventor has not tried such a process.

It is currently preferred that the liner extend above the rim of container 20, to allow the liner to be easily grasped and removed or otherwise manipulated. Referring to FIG. 3, extending liner top 10a above, e.g., about one-half inch above, upper rim 20a of glass 20 will also allow use of an additional amount of the beverage that is displaced by the liner volume.

In another aspect of the invention, beverage container 20 may be manufactured either from glass or, more preferably, from a rubbery plastic material that resists breakage, such as a plastic resin, e.g., acrylic plastic. Preferably the beverage container may be colored. Preferably, container 20 is made of one piece, although for economy in packing and shipping the stems and bowl portion may be designed to snap or press-fit together, for example.

In one preferred container design, shown in FIG. 2, container 20 takes the form of a margarita glass with the following dimensions which will allow it to be placed within the top shelf of a conventional dishwasher: “A” of 1 and ½ inches; “B” of 1 and 1/2 inches; a 3-inch base length “C”; and a top diameter “D” of 4 and 7/8 inches. Of course, suitable liners may be designed for containers 20 having any other dimensions.

While not preferred, it is envisioned that in certain informal environments it may be preferred to utilize a base supporting a disposable “liner” 10 which itself forms the container 20.

In a particularly preferred embodiment, beverage containers 20 may be made available in various colors with color-coordinating insulating inserts 10. The principles of the present invention may also be applied to beverage containers for housing various types of drinks, such as other frozen drinks such as daiquiris, as well as non-frozen drinks that need to be maintained in either chilled or heated condition. A line of colored frozen drink containers and correspondingly-colored inserts may also be designed, e.g., green glasses and green inserts for margaritas; red “hurricane” glasses and red inserts for daiquiris, etc.

Preferably, the lined container of the present invention comes with a straw having a larger diameter that is larger than conventional straws (e.g., a diameter of between about ¼ and ½ inch), and that is preferably thicker and more durable such that it may be reusable. For use with frozen drinks, the straw preferably terminates in a spoon-shaped end which facilitates straw suction of the frozen drink, and which also allows the beverage drinker to stir the beverage. The straw may be colored to correspond or coordinate with the colors of the liners and/or the beverage containers. These straws may be of varying lengths depending on the size of the container that is employed.

Although not necessary, for greater insulation, liner 10 could be designed with an insulating, removable top (not shown in the drawings), which may also be disposable. In a particularly preferred embodiment of the invention, a lined container may be provided in which the liner sides are made of an insulating material such as styrofoam, and a removable top is provided, such as a peelable aluminum or plastic top, similar to the peelable tops currently available with Jello®, yogart or applesauce containers. In this manner a complete, ready-to-drink margarita, for example could be provided, pre-packaged, within the lined container. The removable top may also be provided with an insertion area designed to accommodate the straw, as employed by flexible juice containers for children.

Other changes and modifications constituting insubstantial differences from the present invention, such as those expressed here or others left unexpressed but apparent to those of ordinary skill in the art, may be made without departing from the spirit and scope of the present invention and without diminishing its attendant advantages. It is, therefore, intended that such changes and modifications be covered by the following claims.

1. A disposable liner for insulating a beverage within a drink container, comprising:
a disposable, insulating material generally shaped and sized so as to be insertable within an interior of the drink container,
wherein when a beverage is poured into the drinking container, the beverage is contained and insulated by the liner, providing the ability to maintain the beverage in its initial condition for a substantially longer period of time than if the beverage were in an unlined container.

2. The liner of claim 1, wherein the beverage comprises a frozen drink.

3. The liner of claim 1, wherein the initial condition comprises a chilled condition.

4. The liner of claim 1, wherein the initial condition comprises a heated condition.

5. The liner of claim 1, wherein the liner substantially covers the interior of the container.

6. The insulating device of claim 1, wherein the insulating material comprises styrofoam.

7. The insulating device of claim 1, wherein the liner is colored to correspond to or to coordinate with a particular beverage within the drink container.

8. The insulating device of claim 1, wherein the liner is colored to correspond to or to coordinate with a color or colors of the beverage container.

9. The insulating device of claim 1, wherein the liner extends above the top of the container.

10. The insulating device of claim 1, wherein the liner includes a groove mating with a rim of the container, limiting relative movement between the container and the liner.

11. The insulating device of claim 1, further comprising a removable top designed to fit over the liner so as to substantially enclose the beverage within the liner and the top.

12. The insulating device of claim 11, wherein the top is made of an insulating material.

13. A frozen drink container, comprising:
a material designed to resist breakage; and
a disposable liner made of an insulating material shaped and sized to be inserted within the frozen drink container and to substantially cover an interior of the container, wherein when a frozen beverage is poured into the container, the beverage is contained and insulated by the liner.

14. The frozen drink container of claim 13, wherein the material comprises a plastic resin.

15. A drink container, consisting of:
a disposable, insulating enclosure containing and insulating a beverage poured within the enclosure; and
a base removably connected to the insulating enclosure which supports the insulating enclosure.

16. A drink container, comprising:
a material designed to resist breakage; and
a disposable liner made of an insulating material shaped and sized to be inserted within the drink container and to substantially cover an interior upper surface of the container, wherein when a beverage is poured into the container, the beverage is contained and insulated by the liner; and
a removable top fitting over the disposable liner, the top and the liner together entirely enclosing the beverage.

17. The drink container of claim 16, wherein the removable top forms a hermetic seal with the liner, and the top is peelable from the liner.

18. The drink container of claim 16, wherein the beverage is a ready-to-drink beverage.

19. The drink container of claim 19, wherein the beverage comprises a frozen drink.

20. The drink container of claim 19, wherein the beverage comprises a frozen margarita.

21. The drink container of claim 16, wherein the removable top has an insertion area for a straw having a spoon-shaped end.
